(19) United States
(12) Patent Application Publication
(10) Pub. No.: US 2016/0131794 A1
(43) Pub. Date: May 12, 2016

(54) SYSTEMS AND METHODS FOR A GRAVITY SURVEY USING A FREE-FALL GRAVITY SENSOR

(71) Applicant: CGG Services SA, Massy (FR)

(72) Inventor: Mark Dransfield, Viewbank (AU)

(21) Appl. No.: 14/933,385

(22) Filed: Nov. 5, 2015

Related U.S. Application Data
(60) Provisional application No. 62/078,496, filed on Nov. 12, 2014.

(51) Int. Cl. G01V 7/16; G01V 7/02; G01V 7/14

(52) U.S. Cl. CPC G01V 7/16; G01V 7/14; G01V 7/02

(57) ABSTRACT

Systems and methods for a gravity survey using a free-fall gravity sensor are disclosed. The method includes determining a configuration for a gravimeter for use in a moving-base gravity survey. The gravimeter is operable to obtain absolute gravity measurements. The method further includes obtaining a set of gravity data from the moving-base gravity survey, and correcting the set of gravity data for interference. The method additionally includes generating a gravity model based on the corrected set of gravity data.

### CROSS-REFERENCE TO RELATED APPLICATION

The present application claims the benefit of priority under 35 U.S.C. §119 from U.S. Provisional Patent Application Ser. No. 62/078,496, filed on Nov. 12, 2014, which is incorporated by reference in its entirety for all purposes.

### TECHNICAL FIELD

The present disclosure relates generally to gravity surveys and, more particularly to a gravity survey using a free-fall gravity sensor.

### BACKGROUND

Gravity modeling is a method of geophysical exploration that uses measurements of variations in the earth's gravitational field to estimate properties of the earth's subsurface. Gravity modeling is based on a gravity survey. The gravity of the earth has an average value of 9.8 m/s², but it actually varies from 9.78 m/s² at the equator to 9.83 m/s² at the poles. Density variations of the earth's interior contribute to these gravity variations. Gravity exploration uses measurements of these gravity variations to study the interior of the earth.

Gravity is measured as acceleration. An instrument used to measure the strength or magnitude of gravity can be referred to as a gravimeter, a gravity meter, or a gravity sensor. A gravity sensor may measure the gravitational potential, acceleration, gradient, or any higher spatial gradient of an area or any combination thereof. Gravimeters typically measure the vertical component of the total gravity vector of the earth in units of acceleration at a particular location. A gravimeter can be used to estimate the rise or drop of the earth's surface, changes of materials in the subsurface, and the nature of soil from a gravity distribution. Generally, the gravity unit of m/s² is too big for geophysical exploration applications. Thus, the common unit of measurement of gravity is the “Gal,” and typically mGal is used as the unit of the gravity variation, where 9.8 m/s²=980,000 mGal. A typical peak-to-peak range of gravity variation in a petroleum exploration project is on the order of approximately tens of mGal.

Gravimeters essentially fall into two categories: a relative gravity measurement instrument known as a relative gravimeter, and an absolute gravity measurement instrument known as an absolute gravimeter. Both types of gravimeters measure the vertical component of the earth's total gravity vector. An absolute gravimeter measures the absolute value of gravitational acceleration with a precision of eight to nine figures, for example, a value near 9.8 m/s². A relative gravimeter measures the gravity difference between two measurement points, or changes in gravity over time at one measurement point.

Gravity measurements can be acquired, using a relative gravimeter, on land, on the sea surface (from a moving marine vessel), on the seafloor, or in air (on a flying aircraft, airship, or satellite). A land gravity survey is typically static: gravity meters remain at a location for minutes while taking readings, and then move to the next location. Each location is called a station. Ideally, the distribution of land survey stations will be regular. In contrast, marine and airborne gravity surveys are dynamic. Gravity surveys performed from a moving vehicle (for example, marine vessel or aircraft) are called “moving-base” gravity surveys. In moving-base gravity surveys, measurements are taken along pre-defined vessel and flight lines. Data are sampled along these lines using a certain sampling rate (in time or distance). In a typical land survey, one or more gravimeters may be used. In a typical marine or airborne survey, generally, only one gravimeter is used. Gravity readings and their coordinates can be exported from a gravimeter system to a computing device or other data storage device.

The variation in measured gravity values is attributable to a combination of many effects. For example, the measurement may be influenced by the gravitational attraction of the moon and the sun, or the drift effect due to an imperfection of the materials used to build a gravimeter. However, in gravity modeling, only the gravity effects due to density variations of the earth's interior are of interest. Thus, a systematic process is used to estimate or compute these unwanted effects and then remove them from the measured gravity.

The typical relative gravimeter suspends a mass of known quantity with a spring-like device, such as a metal or quartz spring. An increase in gravity interacts with the known mass to slightly stretch or elongate the spring-like device. Conversely, a decrease in gravity allows the spring-like device to constrict slightly. In both cases, the position of the known mass changes by a slight amount due to the elongation or constriction of the spring-like device. The amount of physical displacement of the known mass is directly related to the magnitude of gravity at that location and time. A spring provides a restoring force and changes in gravity are inferred from changes in either the mass displacement or in the restoring force. In all such instruments, the change in gravity is measured from time to time (and place to place).

The moving-base gravity sensors presently in use are typically relative gravimeters, for example, the mass-spring type. A relative gravimeter is generally small-sized and mobile, but cannot be used in observing a long-period fluctuation because of the drift of a spring. Therefore, a relative gravitational difference with respect to a certain gravitational reference point is measured, and then the absolute value is estimated. In a relative gravimeter, the spring-like device that suspends the known mass is susceptible to many influences that degrade the accuracy of the gravity measurements obtained. Changes in temperature and the age of the spring-like device can change its spring characteristics and hence, change the displacement of the known mass. Changes in atmospheric pressure can also change its spring characteristics. The changes in the spring characteristics of the spring-like device are referred to as drift. Schemes such as reciprocating measurement in a short time are required for correcting the drift. Further, shocks caused by physical movement of a relative gravimeter can alter the at-rest position of the known mass. Changes in the at-rest position of the known mass are referred to as offset or tare. If these changes are not recognized and corrected, the resulting changes are interpreted incorrectly as influenced by gravity.

In contrast, the gravity measurements obtained by using an absolute gravimeter have improved accuracy and measure the total gravity field in each measurement. Further, drift in absolute gravimeters is negligible. However, a conventional absolute gravimeter may be large, and may lack the mobility required for use in a moving-base gravity survey.

Free-fall gravimeters are a type of absolute gravimeter. Free-fall gravimeters operate by measuring the time taken for a mass to fall a certain distance and inferring the average gravitational acceleration over that distance. A free-fall gravity gradiometer measures the separation of two independent masses in free-fall using two free-fall gravimeters or a similar instrument. Most free-fall gravimeters measure the gravity acceleration that a body in free-fall is subjected by means of optical interferometry through wave superposition. The sensitivity that may be achieved by optical interferometry gravimeters is limited by the mechanics of the falling body and the arm of the interferometer that measures the fall distance. In order to overcome the accuracy limits of optical interferometry gravimeters, atomic interferometer gravimeters may be used. Atomic interferometer gravimeters are a type of free-fall gravimeter that measure the phase shift between two clouds of cold atoms, in different momentum states, after free-fall. However, atomic interferometer gravimeters may weigh up to approximately 350 kg and have a height of up to approximately 1.5 meters, which can limit the use of atomic interferometer gravimeters in moving-base applications. Gravity measurements over an area by mass-spring gravity sensors require repeat measurements over several locations in order to acquire data from which the drift may be estimated and corrections to the data thereby made. In addition, they require additional measurements to tie the data to known total field measurements at fixed locations. As such, gravity surveys using mass-spring gravity sensors require significant effort and are limited in the accuracy that is achievable. Thus, there is a need for a technique to improve moving-base gravity surveys to reduce time, expense, and error correction required.

### SUMMARY

In accordance with some embodiments of the present disclosure, a method for a gravity survey is disclosed. The method includes determining a configuration for a gravimeter for use in a moving-base gravity survey. The gravimeter is operable to obtain absolute gravity measurements. The method further includes obtaining a set of gravity data from the moving-base gravity survey, and correcting the set of gravity data for interference. The method additionally includes generating a gravity model based on the corrected set of gravity data.

In accordance with another embodiment of the present disclosure, a gravity survey system includes a gravimeter operable to obtain absolute gravity measurements and a computing system that includes a processor and a memory coupled to the processor. The system further includes instructions stored on in the memory that, when executed by the processor, cause the processor to determine a configuration for the gravimeter for use in a moving-base gravity survey, and obtain a set of gravity data from the moving-base gravity survey. The processor is further caused to correct the set of gravity data for an interference, and generate a gravity model based on the corrected set of gravity data.

In accordance with another embodiment of the present disclosure, a non-transitory computer-readable medium includes instructions that, when executed by a processor, cause the processor to determine a configuration for a gravimeter for use in a moving-base gravity survey. The gravimeter is operable to obtain absolute gravity measurements. The processor is further caused to obtain a set of gravity data from the moving-base gravity survey, correct the set of gravity data for an interference, and generate a gravity model based on the corrected set of gravity data.

### BRIEF DESCRIPTION OF THE DRAWINGS

For a more complete understanding of the present disclosure and its features and advantages, reference is now made to the following description, taken in conjunction with the accompanying drawings, which may include drawings that are not to scale and wherein like reference numbers indicate like features, in which:

FIG. 1 illustrates an exemplary plot of position as a function of time for an atomic interferometer gravimeter in accordance with some embodiments of the present disclosure;

FIG. 2 illustrates a gravity survey system in accordance with some embodiments of the present disclosure; and

FIG. 3 illustrates a flow chart of an example method for a gravity survey using a free-fall gravity sensor in accordance with some embodiments of the present disclosure.

### DETAILED DESCRIPTION

The following description of the exemplary embodiments refers to the accompanying drawings. The same reference numbers in different drawings identify the same or similar elements.

Free-fall gravity sensors may be difficult to use in moving-base gravity surveys due to their size as discussed above. Further, in a free-fall gravity sensor, the mass is in free-fall, independent of the motion of the platform, while the housing and control systems are connected to the platform and constrained in some way to move with the platform. The non-inertial movement of the platform can be large over long periods; however, the non-inertial movement may be small over short periods. Moreover, when a gravimeter is used in airborne applications, the multi-axis movements and structural flexure of the aircraft may modify the acceleration due to any change in gravity. Such modifications may have to be compensated for when the gravity data is processed.

Another aspect of free-fall gravimeters is that the sensitivity of the measurements increases as the time spent in free-fall increases. Thus, increasing free-fall times may increase accuracy. For example, free-fall gravimeters may be configured such that a mass is free falling for a distance on the order of approximately tens of centimeters in a vacuum chamber. The position of the falling mass is typically measured using interferometric techniques. In the subject configuration, sensitivities for free-fall gravimeters may be approximately a few microGal (1⁻⁸ m/s²). For atomic interferometer gravimeters, the corresponding free-fall time may be approximately 0.1 seconds (100 milliseconds (ms)).

However, the sensitivity of gravity data delivered from a moving-base gravity survey may be approximately 1 mGal in 100 seconds (10⁻⁴ m/s² per root Hertz (Hz)). As such, the accuracy of the data is limited by the difficulty of correcting for the accelerations and pseudo-accelerations of the platform on which the gravity measurement is taken and not based on limitations of the sensor. Thus, free-fall gravimeters are able to detect changes in gravity data to a greater degree than is possible or necessary based on the gravity data itself. Accordingly, in some embodiments, a decreased free-fall time for a free-fall gravimeter may be configured without affecting the accuracy of the gravity measurements.

In some embodiments, the use of a free-fall gravimeter configured with a short free-fall time may allow increased use of free-fall gravimeters in moving-base gravity surveys. Using free-fall gravimeters may save time and expense, may reduce errors by eliminating the need of mass-spring sensors to repeat measurements over several locations to estimate and correct for drift, and may eliminate the need to take additional measurements to tie the data to known total field measurements at fixed locations. Consequently, in some embodiments of the present disclosure, it may be advantageous to use a free-fall gravity sensor with a very short free-fall time in a moving-base gravity survey.

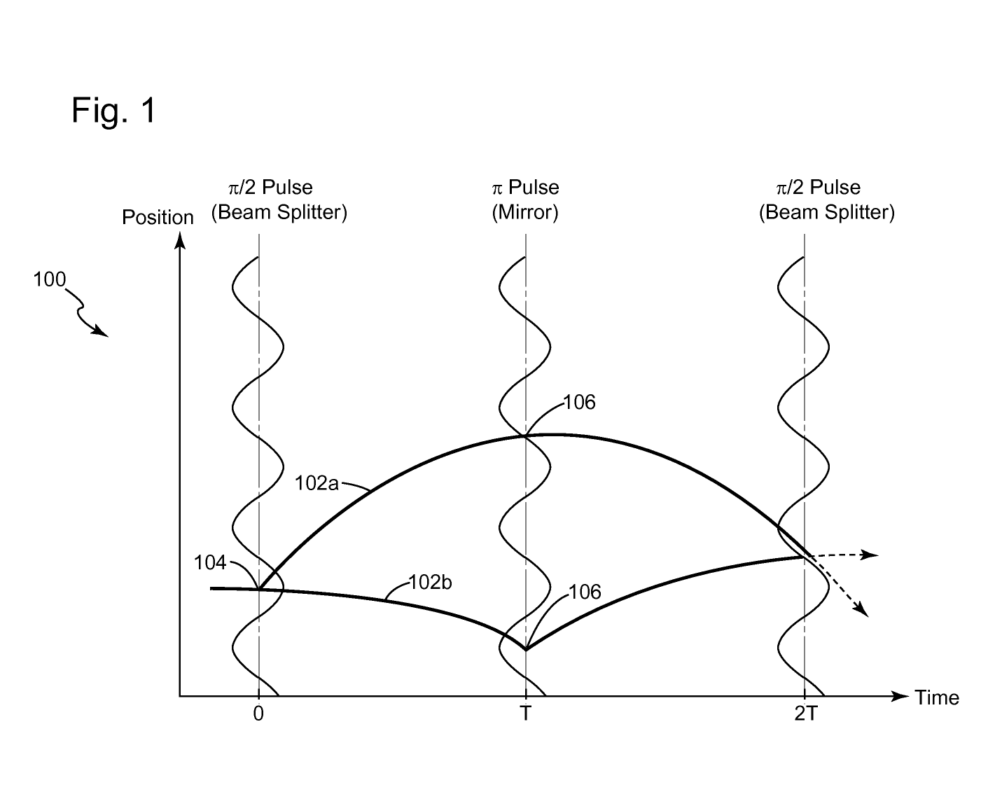

FIG. 1 illustrates an exemplary plot 100 of position as a function of time for an atomic interferometer gravimeter according to some embodiments of the present disclosure. For example, plot 100 may reflect characteristics of a Mach-Zehnder atomic interferometer, or any other suitable atomic interferometer configuration. In atomic interferometer gravimeters, one or more groups of atoms are laser-cooled using light radiation almost resonant with an atomic transition. The cooling or slowing-down process brings the atoms to such low temperatures (a few micro-Kelvin or less) that the undulating nature of the atoms becomes significant and the corresponding de Broglie wavelength can be comparable to the distance among the atoms. The atomic waves then interfere like light waves in optical interferometry. However, unlike optical interferometry gravimeters, atomic interferometer gravimeters do not measure the acceleration of a body in free-fall but rather the movements of one or more groups of atoms.

According to some embodiments, an absolute gravity sensor with a short free-fall time is used to deliver moving base gravity measurements of the total desired field. For example, atomic interferometer gravimeters may be used to measure gravity in a moving-base gravity survey. A moving cloud of cold atoms in an initial or ground state is subjected to three pulse beams. Cold atoms in an initial state are prepared at the bottom of a chamber and launched upward or prepared at the top of the chamber and allowed to fall, for example beam 102b. A π/2 pulse will separate the wavefunction of each atom into two waves. Plot 100 illustrates the vertical position of cold atom beams 102a and 102b as a function of time. In operation, at time 0, a cold atom beam is split by a beam splitter, for example a π/2 pulse from a laser, that changes the momentum state as shown at position 104. Beam 102a, after time 0, corresponds to the trajectory of an excited state beam of atoms with positive vertical momentum. Beam 102b corresponds to an unexcited state beam of atoms, which continues to fall under the influence of gravity. At time T, a beam mirror, for example a π pulse, is implemented to change the momentum of beam 102b at position 106 to reflect in approximately the opposite direction. For example, at position 106 beam 102b is reflected up. At time 2T, a second beam splitter, for example a π/2 pulse or laser, operates to restore the states of beams 102a and 102b and recombine the beams. Beams 102a and 102b have experienced relative phase changes due to interactions with the pulses or lasers, and due to travelling along different paths within the chamber. The latter results in a phase change proportional to the magnitude of the gravity field and to the square of T. Accordingly, the magnitude of the gravity field may be calculated, and a measurement of the gravity field is obtained. In a moving-base gravity survey, this process may be repeated numerous times to generate a measurement of the varying gravity field throughout the desired survey region.

Although discussed with reference to an atomic interferometer gravimeter, in some embodiments, other free-fall gravimeters may be utilized. For example, a falling corner cube gravimeter may also be utilized.

In some embodiments, the distance of the free-fall, and thus the free-fall time, may be reduced. In addition to reducing the size of the free-fall gravimeter, this reduction in distance, and corresponding time, may reduce interference from the moving-base system that appears in the obtained gravity measurements. For example, the free-fall distance may be reduced from approximately tens of centimeters to a range close to approximately 0.5 millimeters, thereby reducing the free-fall time from approximately 100 milliseconds to approximately 10 milliseconds.

According to some embodiments, the free-fall gravimeter may be in any suitable moving vehicle to conduct the moving-base gravity survey. For example, a survey may be conducted in an aerial vehicle, a ground vehicle, or a marine vehicle. An aerial vehicle may be advantageous to avoid physical barriers of ground or marine surveys.

In aerial vehicles, aircraft dynamics at low frequencies (less than a few Hertz) are dominated by the dynamics of the aircraft as a whole, due to turbulence, wind, and directed maneuvers. At high frequencies, vibration of the airframe and mechanical and acoustic transmission of those vibrations due to the engine dominate. The major significant source of dynamics is vibration of parts of the airframe excited by turbulent air. The actual frequencies depend on the aircraft engine, and these frequencies may be measured and recorded. Thus, in some embodiments, the free-fall gravimeter may be operated in a frequency range where only the engine vibration is significant. Accordingly, with the engine frequency known, compensation calculations may be made to remove any effect at high frequencies of the various vibrations caused by the engine to determine a more accurate gravity field measurement

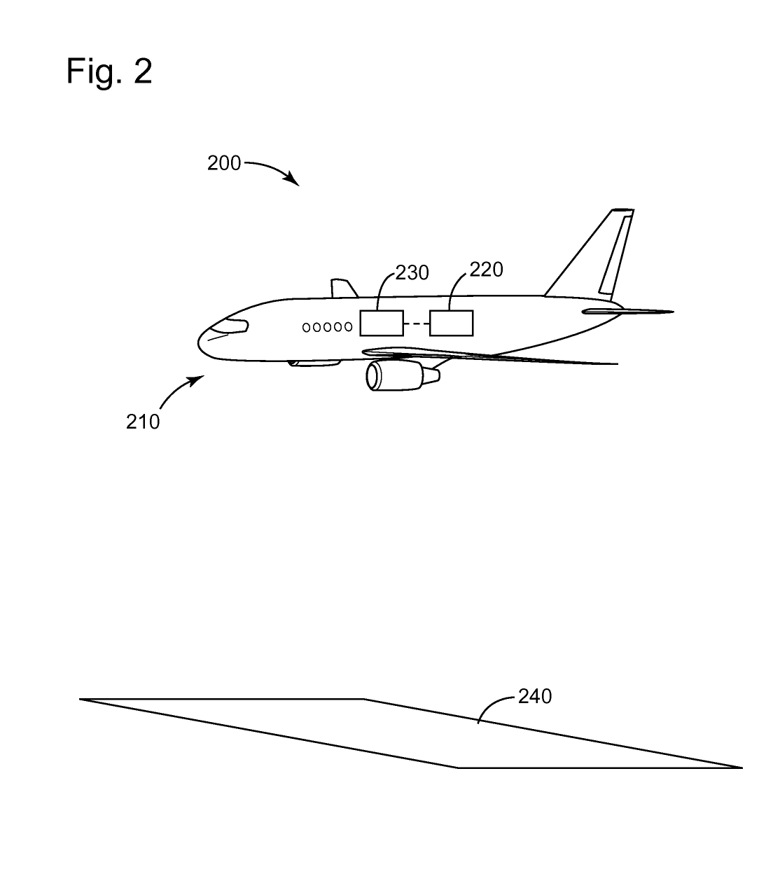

FIG. 2 illustrates a gravity survey system 200 according to some embodiments of the present disclosure. For example, an airplane 210 may be the moving vehicle used to conduct the gravity survey. Airplane 210 may be equipped with a gravimeter 220. Gravimeter 220 may be arranged in airplane 210 to minimize vibrations and the effects of movements of airplane 210 on gravimeter 220. Airplane 210 may be configured to make successive passes over survey area 240 to measure and record gravity data. Survey area 240 may be any particular area of the earth's surface.

In order to record and analyze data, gravimeter 220 is communicatively coupled, connected, or coupled via a network to one or more computing devices 230. Gravimeter 220 transmits gravity survey measurements and other data to computing device 230. A particular computing device 230 can also transmit gravity survey data to other computing devices or other sites via a network. Computing device 230 may include any instrumentality or aggregation of instrumentalities operable to compute, classify, process, transmit, receive, store, display, record, or utilize any form of information, intelligence, or data. For example, computing device 230 may be a personal computer, a storage device, or any other suitable device and may vary in size, shape, performance, functionality, and price. Computing device 230 may include random access memory (RAM), one or more processing resources such as a central processing unit (CPU) or hardware or software control logic, or other types of volatile or non-volatile memory. Additional components of computing device 230 may include one or more disk drives, one or more network ports for communicating with external devices, various input and output (I/O) devices, such as a keyboard, a mouse, and a video display. Computing device 230 is configured to permit communication over any type of network, such as a wireless network, a local area network (LAN), or a wide area network (WAN) such as the Internet. In some embodiments, gravity survey data may be directly transmitted to an external location such that computing device 230 is not required.

Gravimeter 220 may be configured as described above with respect to FIG. 1. Thus, gravity survey system 200 may be configured to obtain absolute measurements of gravity of survey area 240 with negligible drift.

According to embodiments of the present disclosure, the special properties of an airship, blimp, or other aircraft that has the major part of its lift provided by a large volume of light gas may be utilized in conjunction with the described free-fall gravity sensor to perform a moving-base gravity survey. These aircraft are characterized by low levels of experienced engine vibration in the cargo or passenger hold because the engines are mechanically separated by a non-rigid connection, which acts to damp those vibrations, reducing them significantly in amplitude. These aircraft, however, may have significant low frequency acceleration amplitudes due to their tendency to easily pitch and roll, thereby coupling in variable proportions of the earth's acceleration. Nevertheless, these low frequency acceleration amplitudes may be measured and known, such that compensation calculations may be made to remove any effect at low frequencies caused by the pitch and roll of the airship. Thus, in some embodiments, gravimeter 220 and computing system 230 may be located in an airship that may be a blimp or any other suitable aircraft with a large volume of light gas. In such a case, gravimeter 220 may be arranged in the airship to minimize vibrations and the effects of the movement of the airship (pitch and roll) on gravimeter 220.

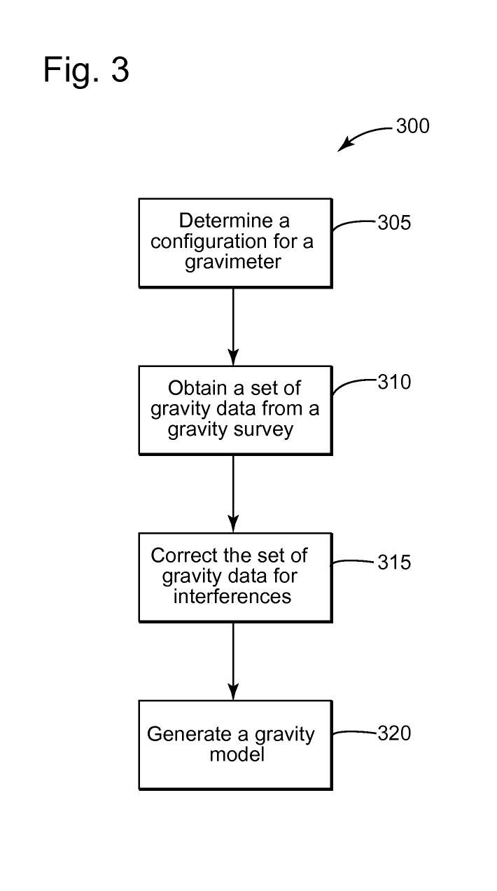

FIG. 3 illustrates a flow chart of an example method 300 for a gravity survey using a free-fall gravity sensor in accordance with some embodiments of the present disclosure. The steps of method 300 are performed by a user, various computer programs, models configured to process or analyze gravity data, or any combination thereof. The programs and models include instructions stored on a non-transitory computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to process and analyze seismic data may be referred to as a “computing device.” For illustrative purposes, method 300 is described with respect to gravity data based on gravity survey area 200 of FIG. 2; however, method 300 may be used to characterize gravity data from any suitable gravity survey area.

At step 305, the computing device determines a configuration for the gravimeter. The configuration may be based on a free-fall gravimeter with a reduced free-fall distance. For example, the free-fall gravimeter may be configured with a free-fall distance of approximately 0.5 millimeters, as discussed with reference to FIG. 1. Further, the configuration of the free-fall gravimeter may be based on frequencies associated with an engine for the means of transportation into which the free-fall gravimeter is to be mounted. For example, the engine frequencies for aircraft 210, discussed with reference to FIG. 2, may be determined and the free-fall gravimeter may be configured to operate substantially outside of that frequency if possible.

At step 310, the computing device obtains a set of gravity data from a gravity survey performed by the gravimeter. A moving-base gravity survey may be conducted using the free-fall gravimeter discussed in step 305. The gravity data collected may be transferred or otherwise communicated to the computing device.

At step 315, the computing device corrects the set of gravity data for interference. Corrections may be made based on interference from known frequencies. For example, the computing device may correct the gravity data using compensation calculations based on the known frequencies of an engine operated in aircraft 210. Additional corrections may include corrections for turbulence, pitch and roll, the rotation of the earth, other gravity corrections, or any other suitable interference.

At step 320, the computing device utilizes the corrected data to generate a gravity model. For example, the computing device may use the corrected data to generate a gravity model for area 240, discussed with reference to FIG. 2.

Modifications, additions, or omissions may be made to method 300 without departing from the scope of the present disclosure. For example, the steps may be performed in a different order than that described and some steps may be performed at the same time. Further, more steps may be added or steps may be removed without departing from the scope of the disclosure.

The foregoing detailed description does not limit the disclosure. Instead, the scope of the disclosure is defined by the appended claims. The described embodiments are not limited to the disclosed configurations, and may be extended to other arrangements.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. For example, a receiver does not have to be turned on but must be configured to receive reflected energy.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. For example, the transmitting waveform, receiving sensed signals, and processing of received signals processes may be performed through execution of computer program code in a computer-readable medium.

Embodiments of the present disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium or any type of media suitable for storing electronic instructions, and coupled to a computer system bus. Furthermore, any computing systems referred to in the specification may include a single processor or may be architectures employing multiple processor designs for increased computing capability.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate. Instead, the scope of the present disclosure is defined by the appended claims.

What is claimed is:

1. A method for a gravity survey comprising:
determining a configuration for a gravimeter for use in a moving-base gravity survey, the gravimeter operable to obtain absolute gravity measurements;
obtaining a set of gravity data from the moving-base gravity survey;
correcting the set of gravity data for interference; and
generating a gravity model based on the corrected set of gravity data.

2. The method of claim 1, wherein the gravimeter is a free-fall gravimeter.

3. The method of claim 1, wherein the gravimeter is an atomic interferometer gravimeter.

4. The method of claim 1, wherein the gravimeter is a falling corner cube gravimeter.

5. The method of claim 2, wherein the free-fall gravimeter is configured with a short free-fall distance.

6. The method of claim 5, wherein the short free-fall distance is less than approximately 10 millimeters.

7. The method of claim 1, wherein the set of gravity data is based on a moving-base gravity survey performed on an aircraft.

8. The method of claim 7, wherein the interference is based on a frequency of an engine on the aircraft.

9. The method of claim 1, wherein the set of gravity data is based on a moving-base gravity survey performed on an airship.

10. The method of claim 9, wherein the interference is based on a pitch experienced by the airship.

11. A gravity survey system comprising:
a gravimeter operable to obtain absolute gravity measurements;
a computing system comprising:
a processor;
a memory coupled to the processor;
instructions stored on in the memory that, when executed by the processor, cause the processor to:
determine a configuration for the gravimeter for use in a moving-base gravity survey;
obtain a set of gravity data from the moving-base gravity survey;
correct the set of gravity data for an interference; and
generate a gravity model based on the corrected set of gravity data.

12. The system of claim 11, wherein the gravimeter is a free-fall gravimeter.

13. The system of claim 11, wherein the gravimeter is an atomic interferometer gravimeter.

14. The system of claim 11, wherein the gravimeter is a falling corner cube gravimeter.

15. The system of claim 12, wherein the free-fall gravimeter is configured with a short free-fall distance.

16. The system of claim 15, wherein the short free-fall distance is less than approximately 10 millimeters.

17. A non-transitory computer-readable medium, comprising instructions that, when executed by a processor, cause the processor to:
determine a configuration for a gravimeter for use in a moving-base gravity survey, the gravimeter operable to obtain absolute gravity measurements;
obtain a set of gravity data from the moving-base gravity survey;
correct the set of gravity data for an interference; and
generate a gravity model based on the corrected set of gravity data.

18. The non-transitory computer-readable medium of claim 17, wherein the gravimeter is a free-fall gravimeter.

19. The non-transitory computer-readable medium of claim 17, wherein the gravimeter is an atomic interferometer gravimeter.

20. The non-transitory computer-readable medium of claim 17, wherein the gravimeter is a falling corner cube gravimeter.
